(19) United States
(12) Patent Application Publication
(10) Pub. No.: US 2015/0117146 A1
(43) Pub. Date: Apr. 30, 2015

(54) SOLID STREAMER LONGITUDINAL BODY APPARATUS AND METHOD OF USE THEREOF

(71) Applicant: Richard E. Pearce, Weatherford, TX (US)

(72) Inventor: Richard E. Pearce, Weatherford, TX (US)

(21) Appl. No.: 14/066,422

(22) Filed: Oct. 29, 2013

(51) Int. Cl. G01V 1/20; G01V 13/00

(52) U.S. Cl. CPC G01V 1/201; G01V 13/00; G01V 1/38
USPC 367/15; 264/171.1; 264/45.9

(57) ABSTRACT

Streamers used in mapping strata beneath a marine body are described, such as in a flexible neutrally buoyant towed array. A streamer cable is described using polyurea, within a sleeve, where the polyurea demonstrates durability in the presence of extreme hydrodynamic forces at depths in the marine body. The sleeve optionally uses longitudinal directed, inward pointing ribs to distribute forces and to minimize expansion of micro-cracks. The polyurea is optionally made neutrally buoyant through the controlled dosage of hollow, flexible, and/or glass microspheres into the polyurea at time of polymerization. A stress relieving connector is optionally used to longitudinally join a first and second streamer section and/or to connect a streamer section to a streamer stabilizer.

### CROSS-REFERENCES TO RELATED APPLICATIONS

This application:
is a continuation-in-part of U.S. patent application Ser. No. 13/295,380 filed Nov. 14, 2011;
is a continuation-in-part of U.S. patent application Ser. No. 13/855,129 filed Apr. 2, 2013;
is a continuation-in-part of U.S. patent application Ser. No. 13/915,440 filed Jun. 11, 2013; and
claims the benefit of U.S. provisional patent application No. 61/720,009 filed Oct. 30, 2012,
all of which are incorporated herein in their entirety by this reference thereto.

### TECHNICAL FIELD OF THE INVENTION

The present invention relates to use of sensors to map strata beneath a body of water and/or to sense an object in water.

### DESCRIPTION OF THE RELATED ART

Towed arrays of hydrophone sensors are used to map strata beneath large bodies of water, such as gulfs, straights, and oceans.

Patents related to the current invention are summarized herein.

### Streamer Cable

R. Pearce, “Non-Liquid Filled Streamer Cable with a Novel Hydrophone”, U.S. Pat. No. 5,883,857 (Mar. 16, 1999) describes a streamer cable including a plurality of serially coupled active cable sections having hydrophones located within an outer jacket and a longitudinally and centrally located electromechanical cable.

R. Pearce, “Non-Liquid Filled Streamer Cable with a Novel Hydrophone”, U.S. Pat. No. 6,108,267 (Aug. 22, 2000) describes a towed array having a central strain member, an inner protective jacket about the strain member, a foam material about the inner protective jacket, and a potting material bonded to the inner protective jacket inside an outer protective jacket.

R. Pearce, “Method and Apparatus for a Non-Oil-Filled Towed Array with a Novel Hydrophone and Uniform Buoyancy Technique”, U.S. Pat. No. 6,498,769 B1 (Dec. 24, 2002) describes a towed array having uniform buoyancy achieved using hollow microspheres in a polyurethane matrix, where the percentage of hollow microspheres is correlated with adjacent density of elements of the towed array.

R. Pearce, “Acoustic Sensor Array”, U.S. Pat. No. 6,614,723 B2 (Sep. 2, 2003) describes an acoustic sensor array having buoyant sections formed using reaction injection molding with controlled and varying amounts of hollow microspheres and polyurethane as a function of position on the array.

### Sensor

R. Pearce, “Acoustic Transducer”, U.S. Pat. No. 5,357,486 (Oct. 18, 1994) describes a piezoelectric film strip wrapped around a mandrel having stand off collars on each end. Variations in hydrodynamic pressure flex the film strip in tension to generate a voltage.

R. Pearce, “Acoustic Sensor”, U.S. Pat. No. 5,361,240 (Nov. 1, 1994) describes an acoustic sensor having a hollow mandrel with an outer surface defining a concavity and a flexible piezoelectric film wrapped about the outer surface forming a volume between the film and the mandrel, the volume serving as a pressure compensating chamber.

R. Pearce, “Acoustic Sensor and Array Thereof”, U.S. Pat. No. 5,774,423 (Jun. 30, 1998) describes an acoustic sensor having electrically coupled piezoelectric materials.

R. Pearce, “Acoustic Sensor and Array Thereof”, U.S. Pat. No. 5,982,708 (Nov. 9, 1999) describes an acoustic sensor having a substrate with a concavity on an outer surface that is sealingly enclosed by an active member of a piezoelectric material.

R. Pearce, “Acoustic Sensor and Array Thereof”, U.S. Pat. No. 6,108,274 (Aug. 22, 2000) describes an acoustic sensor having a mandrel, a first substrate on an outer surface of the mandrel, a damping layer between the first substrate and a second substrate, a piezoelectric sensor mounted to the second substrate, and an encapsulating material on the piezoelectric material.

R. Pearce, “Method and Apparatus for a Non-Oil-Filled Towed Array with a Novel Hydrophone and Uniform Buoyancy Technique”, U.S. Pat. No. 6,819,631 B2 (Nov. 16, 2004) describes a towable hydrophone having a diaphragm with a tubular shape, a thin film piezoelectric element attached to the diaphragm, the diaphragm having a back plane having a cylindrical shape, and at least one longitudinal rib on the exterior of the back plane, where the back plane and exterior rib slidingly engage the tubular diaphragm.

### Problem Statement

What is needed is one or more sensors for use in mapping strata under a water body having enhanced durability and increased insensitivity to noise sources.

### SUMMARY OF THE INVENTION

The invention comprises a longitudinal seismic streamer body apparatus and method of use thereof.

### BRIEF DESCRIPTION OF THE DRAWINGS

A more complete understanding of the present invention is derived by referring to the detailed description and claims when considered in connection with the Figures, wherein like reference numbers refer to similar items throughout the Figures.

FIG. 1 illustrates a towed sensor array and potential water body surface interference;

FIG. 2 illustrates longitudinal sleeve ridges;

FIGS. 3A and 3B illustrate a first and second seismic streamer section in an aligned and bent orientation, respectively;

FIGS. 4A and 4B illustrate a first and second seismic streamer section joined by a connector having a stress relief module in an aligned and bent orientation, respectively;

FIG. 5 illustrates a connector having a rigid attaching section and a flexible section;

FIG. 6 illustrates a spring used to constrain bending of a connector;

FIG. 7 illustrates a varying cross-sectional thickness of a spring as a function of x-axis location;

FIGS. 8A and 8B illustrate a spring relief element circumferentially surrounding a portion of a section aligned with a central strain member in an aligned and bent orientation, respectively;

FIG. 9 illustrates a first stress relief element;

FIG. 10 illustrates a second stress relief element; and

FIGS. 11A, 11B, and 11C illustrate a streamer positioner from a perspective, end, and top view, respectively.

Elements and steps in the figures are illustrated for simplicity and clarity and have not necessarily been rendered according to any particular sequence. For example, steps that are performed concurrently or in different order are illustrated in the figures to help improve understanding of embodiments of the present invention.

### DETAILED DESCRIPTION OF THE PREFERRED EMBODIMENTS

The invention comprises a longitudinal seismic streamer body apparatus, method of manufacture, and method of use.

Streamers used in mapping strata beneath a marine body are described, such as in a flexible neutrally buoyant towed array. A streamer cable is described using polyurea, within a sleeve, where the polyurea demonstrates durability in the presence of extreme hydrodynamic forces at depths in the marine body. The sleeve optionally uses longitudinal directed, inward pointing ribs to distribute forces and to minimize expansion of micro-cracks. The polyurea is optionally made neutrally buoyant through the controlled dosage of hollow, flexible, and/or glass microspheres into the polyurea at time of polymerization. A stress relieving connector is optionally used to longitudinally join a first and second streamer section and/or to connect a streamer section to a streamer stabilizer.

In another one embodiment, a connector is used to relieve forces resultant at and/or near a junction of a first seismic streamer section and a second seismic streamer section.

For example, streamers used in mapping strata beneath a marine body are described, such as in a flexible neutrally buoyant towed array, where a connector is used to longitudinally join a first and second streamer section. The connector contains at least one of: (1) means for distributing axial stress over a larger volume or along a longer x-axis length of the streamer relative to the absence of the means for distributing; (2) forming an increasing radius of curvature along the length of the connector as a function of distance from the first leading streamer cable section; and (3) co-moving an inner stress bearing element and an outer wall of the connector allowing intermediate streamer elements, such as a wire bundle from picking up noise related to the movement stress.

In another embodiment, a connector is used to relieve forces resultant at and/or near a junction of a seismic streamer positioner and a seismic streamer section. Herein, the seismic streamer positioner is used for control and/or positive control of one or more of: lateral position of a streamer position, vertical control of a streamer position, roll control of a streamer position, orientation of a streamer cable, depth of a streamer cable, and/or separation of two or more streamer cables in a streamer array.

In yet another embodiment, a set of sensors are embedded within at least two seismic streamer sections. A connector or junction couples a first seismic streamer section with a second seismic streamer section in a manner reducing motion induced noise in the sensor output. Optionally, at least one of the solid streamer sections includes a flexible syntactic elastomer based solid seismic streamer circumferentially encasing a rigid mandrel upon which a sensor element is mounted. The system is used for enhanced data acquisition in marine seismic surveys and passive acquisition.

### Axes

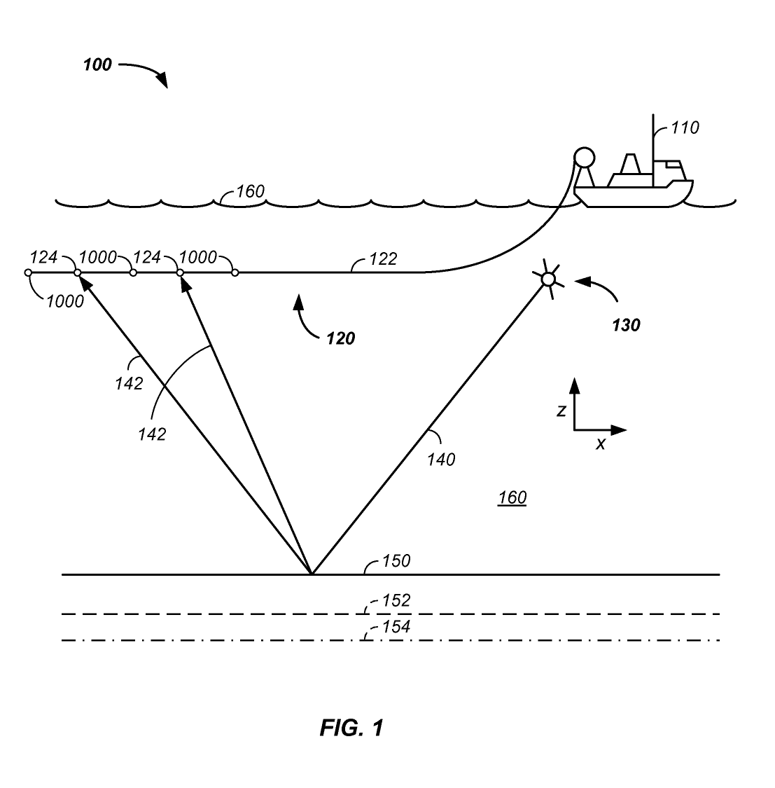

Referring now to FIG. 1, herein an x-axis is in a horizontal direction of towing of a sensor array. The x/y axes form a plane parallel to a water body surface. The z-axis is aligned with gravity. Typically, the thickness of a piezoelectric film is viewed in terms of a z-axis, though the piezoelectric film is optionally rolled about a mandrel, described infra.

### Streamer Section

In this section, elements of a streamer section of the streamer cable 122 are further described.

### Piezoelectric Material

Piezoelectricity is charge that accumulates in certain solid materials in response to applied mechanical stress. A piezoelectric material generates electricity from applied pressure.

An example of a piezoelectric material is polyvinylidene fluoride (PVDF). Unlike ceramics, where the crystal structure of the material creates the piezoelectric effect, in the PVDF polymer intertwined long-chain molecules attract and repel each other when an electric field is applied.

The polyvinylidene material is particularly useful in aqueous environments as the acoustic impedance of PVDF is similar to that of water. An external mechanical force applied to a film of polyvinylidene fluoride results in a compressive or tensile force strain. A film of PVDF develops an open circuit voltage, or electrical charge, which is proportional to the changes in the mechanical stress or strain. By convention, the polarization axis is the thickness axis of the polyvinylidene material. Tensile stress may take place along either the longitudinal axis or the width axis.

Herein, for clarity, polyvinylidene fluoride is used as an example of the piezoelectric material. However, any material that generates a charge in response to pressure is optionally used. Examples include: man-made crystals, such as gallium orthophosphate, a quartz analogic crystal, and langasite; man-made ceramics, such as a titanate, a niobate, a tantalate, or a tungstate; and/or a substantially lead-free piezoceramic.

A PVDF material is characterized in terms of a strip of PVDF film. The PVDF film includes a width axis or x-x axis, a length axis or y-y axis, and a thickness axis or z-z axis. The PVDF film x-x axis is less sensitive, in terms of developed charge, to applied forces than the length axis or the thickness axis of the PVDF film. Hence, in the sensors described herein, the width axis of the PVDF film is typically about parallel to the towing direction of the sensor array to minimize noise signals resultant from towing of the sensor array with a cable under varying strain. Expansion of the y-y axis of the PVDF film is optionally restrained in a mounting step, which results in increased thickness changes of the PVDF film resultant from applied forces. The increased thickness change as a function of applied force is equivalent to an increased signal-to-noise ratio.

The PVDF film is optionally cut, shaped, or wrapped about a surface, such as a mandrel or hollow tube.

A PVDF sensor is a PVDF film coupled with at least one charge transfer element, such as a conductive wire. For example, a PVDF sensor includes a PVDF film coated on both sides with a conductive ink. The conductive ink of the PVDF sensor is electrically attached to electrical lead lines running longitudinally through the streamer cable 122.

### Conditioning Electronics

Electric output from the a sensor is carried along a conductive element, such as a wire, one or more electrical lead lines, and/or a wire bundle 350 to an electrical circuit. The electrical circuit optionally includes: a current to voltage converter, such as a preamplifier, an amplifier, processing electronics, an analog-to-digital converter, and/or a data buss. Signal from a first PVDF sensor is optionally:
combined with signal from a second PVDF sensor using the on-board electrical circuit; and/or
is post processed after communication of the gathered signal to a processing center.

### Towed Sensor Array

Still referring to FIG. 1, a system for mapping strata 100 under a floor 150 of a water body 160 is illustrated. In the illustrated example, a ship 110 tows one or more sensor arrays 120. A sensor array 120 includes at least a streamer cable 122 and a sensor 124.

The streamer cable 122 includes:
a strain member, such as a central strain member or mandrel;
a wire bundle 350 configured to carry power and/or data, the wire bundle is preferably wrapped about the strain member to reduce strain from towing;
a plurality of sensors 124, such as about equispaced or not equally spaced hydrophones, non-acoustic sensors, and/or accelerometers;
electronics;
a buoyancy element; and/or
a protective jacket about the sensors, strain member, and wire bundle.

Elements of the streamer cable 122 are further described, infra.

In use, a seismic shock wave is generated, such as with an explosive 130. For clarity of presentation, a single shock wave 140 from the explosive 130 is illustrated. The shock wave 140 partially reflects from a floor 150 of the water body, and/or from a series of strata layers 152, 154 under the water body floor 150. Again for clarity, only a subset of the surface and strata reflections are illustrated. In one case, the surface reflections yield a vertically rising seismic wave 142 that strikes the one or more sensors 124. In a second case, a seismic wave at least partially reflects off of a water body surface 160 to yield a vertically descending seismic wave 144, which strikes the one or more sensors 124. The vertically descending seismic wave is an interference signal, which reduces the bandwidth and associated signal-to-noise ratio of the sensors 124.

Still referring to FIG. 1, those skilled in the art know that a matrix of sensors may be used to map strata layers, where the matrix of sensors each detect a plurality of seismic waves, each of the seismic waves reflected off of a plurality of strata layers at a plurality of spatial positions as a function of time.

### Sensors

The sensors 124 are further described. Any of the sensors 124 described herein are optionally coated with a flexible solid material as part of the streamer 122. Further, sensors 124 are optionally positioned at any x-axis position of the streamer 122 to form the sensor array 120, though equispacing of like sensor elements 124 is preferred.

### Motion Sensor

The sensors 124 optionally include one or more motion sensors, such as described in U.S. patent application Ser. No. 13/295,356, which is incorporated herein in its entirety by this reference thereto. The motion sensor optionally includes:
a substrate;
a piezoelectric motion film optionally attached to a diaphragm; and
a hollow cavity, hollow chamber, and/or an enclosed chamber between the substrate and the piezoelectric motion film.

In practice, the substrate is optionally a hollow tube or a hollow mandrel. The substrate is sufficiently rigid to isolate internally radiated stresses from the embodied piezo elements in both the motion sensor and the acoustic sensor. The substrate optionally includes a concave inner surface, defining an inner wall of a tube. The tube is optionally used to contain and/or to constrain movement of centrally placed elements, such as a strain member of the streamer cable, the wire bundle configured to carry power and/or data, a shock absorbing element, and/or the electronics. The substrate also optionally includes a convex outer surface upon which the sensor elements are mounted. Similarly, the sensor is optionally positioned between the inner mandrel and within the sensor housing

### Acoustic Sensor

Further, the sensors 124 optionally include one or more acoustic sensors, such as described in U.S. patent application Ser. No. 13/295,380, which is incorporated herein in its entirety by this reference thereto.

In one example the acoustic sensor uses a rigid strain member or mandrel. However, the mandrel is optionally any rigid surface, such as a hollow cylinder or tube about the motion sensor. A piezoelectric acoustic film is wrapped about the mandrel. The piezoelectric acoustic film includes a conductive material on both the outer surface and the inner surface. For example, a first electrical connector is connected to a first flexible conductive ink circuit on the outer surface of the piezoelectric acoustic film. Similarly, a second electrical connector is connected to a second flexible conductive ink circuit on the inner surface of the piezoelectric acoustic film. The first and second electrical conductors electrically connect to the wires or wire bundle 350 running through the streamer. The outer surface of the piezoelectric acoustic film is optionally coated or contained within a flexible solid.

In practice, an acoustic pressure wave 140 is converted to a mechanical motion at the water/flexible solid interface of the sensor 124. The mechanical motion is transferred to the piezoelectric acoustic film, where a change in shape of the piezoelectric acoustic film is picked up as a corresponding electrical signal using the first electrical connector connected to the first flexible conductive ink circuit on the outer surface of the piezoelectric acoustic film and the second flexible conductive ink circuit on the inner surface of the piezoelectric acoustic film. The electrical signal is amplified and processed, as described supra, to yield information on the floor 150 of the water body and on the series of strata layers 152, 154 under the water body floor 150.

### Noise Cancelling Sensor

Still further, the sensors 124 optionally include one or more nose cancelling sensors, such as described in U.S. patent application Ser. No. 13/337,091, which is incorporated herein in its entirety by this reference thereto.

### Multiple Sensors

Multiple sensors are optionally used in each sensor section of the sensor array. For example, output from one or more motion sensor is combined with output from one or more acoustic sensor, output from a first motion sensor is combined with output from a second motion sensor, output from a first acoustic sensor is combined with output from a second acoustic sensor, and/or a noise-cancelling sensor is used with a motion and/or acoustic sensor. The process of combining the signals optionally occurs passively, in a pre-processing stage by use of electronic circuitry, and/or in a post-processing digital signal processing process.

An example of multiple sensors is described in U.S. patent application Ser. No. 13/295,402, which is incorporated herein in its entirety by this reference thereto.

### Stacked Sensors

Optionally, two or more sensors 120 are stacked along the y- and z-axes at a given point or length along the x-axis of the streamer cable 122. Generally, a sensor accelerometer, a non-acoustic sensor, and/or an offset acoustic sensor are optionally positioned in any spatial position relative to each other. For example:
the offset acoustic sensor is optionally positioned radially outward from the non-acoustic sensor;
the non-acoustic sensor is optionally at a first radial distance away from the streamer cable 122 that is different than one or both of a second radial distance between the streamer cable 122 and the acoustic sensor or a third radial distance between the streamer cable and the sensor accelerometer; and/or
the sensor accelerometer, the non-acoustic sensor, and the offset acoustic sensor are vertically stacked.

Stacking of at least two of the sensors reduces the stiff length section(s) of the sensor array 120, which aids in durability and deployment of the sensor array 120.

A means of connecting the electrodes of the film is provided to which wires are attached to a means by which the signal can be passed through an end of the assembly. The wires combine to form elements of the wire bundle 250, which runs longitudinally through the streamer cable 122.

Each individual sensor embodiment is then over molded within one or more layers with the outer layer forming an over molding using an elastomeric flexible syntactic flotation material.

### Signal Wires

Output from the one or more sensors is run through signal wires along at least partial lengths of the streamer cable in the wire bundle 350.

### Buoyancy Element

The outer member of the streamer optionally includes incompressible glass spheres used for buoyancy control. For example, the central elements, such as any of the sensor elements described herein, are encased in an outer element, such as a buoyancy element. The buoyancy element:
is optionally used with any sensor 124 herein;
optionally contains non-compressible glass spheres; and/or
contains varying amounts of the glass spheres to adjust buoyancy as a function of x-axis position and/or as a function of streamer element size and density.

In any of the sensors described herein, any of the layers, such as an outer buoyancy element are optionally configured with glass spheres, which function as a buoyancy element. Generally, the glass spheres are incompressible up to about two thousand pounds per square inch. Glass spheres are useful in maintenance of uniform buoyancy regardless of the depth at which the streamer 120 is towed. A preferred glass sphere has a density of about 0.32 g/cm³; however the glass spheres optionally have a density of less than water and/or less than about 0.9, 0.8, 0.7, 0.6, 0.5, 0.4, 0.3, or 0.2 g/cm³.

In one embodiment, polyurea is used in the streamer 120. Polyurea and the use of polyurea in the streamer is further described, infra.

### Polyurethane

Standard polyurethanes, optionally loaded with flexible hollow glass microspheres, are viable for use in the streamer 120 and in piezo-polymer hydrophones as both components used to make polyurethane are liquid at room temperature and hence are easy to process. However, for some seismic applications, such as use in a streamer under more extreme hydrodynamic forces, such as at deployed depths of greater than 20, 50, or 100 meters, standard polyurethanes are associated with robustness concerns, such as cracking leading to streamer 120 failure.

### Polyurea

Optionally, polyurea is used in the streamer 120. Polyurea is an elastomer derived from the reaction product of an isocyanate component and a resin, such as a synthetic resin through step-growth polymerization. Optionally, the isocyanate is aromatic or aliphatic, is a monomer, a polymer, a prepolymer, and/or is a variant reaction of isocyanates. The resin is optionally an amine-terminated polymer resin and/or an amine terminated chain extender. The resin blend optionally contains one or more additives, such as a hydroxyl, a pigment, and/or a polyol carrier. Optionally, the isocyanate and/or the resin is blended with microsphere additives, such as flexible hollow glass microspheres. An exemplary reaction of an isocyanate and a polyamine to form a polyurea or urea linked polymer is provided in equation 1.

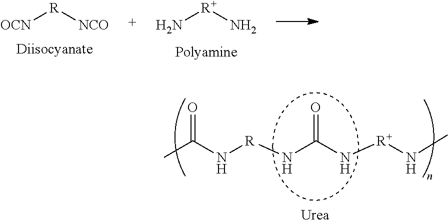

Equation 1: General reaction for forming a polyurea chain, illustrating the two monomer reactants and highlighting the urea linkage in the product where R is any chemical element or group

Generally, urea or carbamide is an organic molecule having two amine groups (—NH₂) joined by a carbonyl functional group (C═O). In a polyurea, alternating monomer units of isocyanates and amines react with each other to form urea linkages. Optionally, ureas are formed from the reaction of isocyanates and water which forms a carbamic acid intermediate, which decomposes by splitting off carbon dioxide and leaving behind an amine. This amine then reacts with another isocyanate group to form the polyurea linkage. This two-step reaction is used to form a polyurea foam. The carbon dioxide liberated in the reaction is the foaming agent. The inventor notes that polyurethane foams are distinct from polyurea foams, especially in use in the streamer 120, where the streamer 120 benefits from the polyurea response to extreme hydrodynamic forces, as described infra.

### Microsphere Loaded Polyurea Elastomeric Flotation Material

The use of polyurea elastomers to create a portion of the streamer 120 provides the necessary buoyancy to allow the streamer 120 to remain neutrally buoyant when towed behind a seismic vessel. The principle reason for this novel and unique to the art technology is the fact that the processing of polyurea requires specific equipment and processes to properly mix the two components together to form the elastomer. Polyurea must be processed under relative high heat conditions for the respective components to remain liquid through the process of blending the microspheres into a B component and high heat to change a “solid” A component to a liquid for processing. Standard polyurethanes have typically low viscosity at room temperature, ranging from a few hundred centipoise to several thousand centipoise. The polyurea compound has a much higher viscosity material possessing viscosities of over 17000 cps for Part A. This dramatically higher viscosity requires special handling and processing of the material in order to effect proper mixing of the respective components. Preferably, the polyurea is formed using at least one component having a viscosity of at least 500, 1000, 5000, or 10,000 centipoise.

### Construction Method of Enhanced Durability Streamer

Polyurea chemistry is optionally used to construct a significantly more durable microsphere loaded polymer or urethane suitable for the extraordinary rigors of seismic streamer applications. The more durable polyurea offers new levels of durability and resistance to hydrodynamic damage making solid streamers using this process suitable for commercial seismic exploration applications.

### Process Description:

Part A is heated to a minimum temperature of 140 degrees Fahrenheit. The heating process is optionally carried out through the use of silicone barrel heaters applied to the drums in which the material is part A component is shipped. The temperature is optionally controlled using a closed loop temperature control system. The heated material is then pumped into a process tank. The process tank temperature optionally remains at a temperature suitable to maintain the required viscosity.

Part B is optionally prepared for blending in the hollow microspheres. As with the part A component, the part B component is optionally pre-heated in the shipping drum to reduce viscosity for ease of blending the spheres. Once the material is at temperature, the material is pumped into a heated mixing chamber where hollow microspheres, such as a 3M® (St. Paul, Minn.) S-32 microsphere, of the required specific gravity are blended into part B. The amount of spheres blended into part B is calculated to produce the slurry of a required specific gravity. The specific gravity of the slurry is calculated based on the specific gravity requirements of the mixed components, part A+part B+microspheres. The slurry of part B and the microspheres is then pumped into the part B heated process tank. Temperature of the part B slurry is preferably maintained at the necessary temperature to maintain the low viscosity of the slurry.

### Metering of the Two Component Microsphere Loaded Polyurea:

The blending of the components now resident in the heated process tanks is performed using very precise and/or accurate pumping and mixing technology. The material is pumped either through a double acting piston type pump system or, preferably, is pumped using a progressive cavity pump system. The material is pumped through hoses to the metering head, the flow from which is controlled by valves. The two components are then passed through a static mixing system that properly mixes the component A and the component B slurry together. In this description, the static mixing elements are resident in a cavity inside of the two part mold, allowing the metering head to be robotically controlled. In this description there are multiple mold cavities in which the electronic components of the streamer reside. Parts A and B slurry pass through the static mixing cavity and through a runner system which deposits the mixed material into the mold cavity.

### Streamer Electronic Chassis:

A streamer electronic chassis is optionally used that comprises a central electromechanical cable assembly that contains the strain carrying stress member, such as an aramid fiber core of sufficient size to withstand the loads presented to the streamer under operational conditions while being towed, deployed, and recovered from the vessel. About the stress member are the electrical wires, which are optionally wrapped as a helix along the length of the streamer 120 in a torque balanced construction with the inner lay a right hand helix and the outer lay a left hand helix or vise-versa. The electrical bundle is then optionally covered with extruded polyurethane or polyurea with an optional weave of aramid fiber, which re-enforces the strength of the polyurethane jacket. This re-enforcement is preferred to allow stress to be applied to the cable when it is placed in the mold for over molding using the polyurea flotation material.

Optionally, the streamer 120 is built in sections, such as about 37.5, 75, and 150 meters in length. Each streamer section is optionally terminated into a waterproof electromechanical coupler that carries the load and the electrical signals from the hydrophone groups. Each streamer section optionally attaches through its coupler to a digital telemetry module where the signals from the hydrophones are digitized and then transmitted through the adjoining sections to a data recording system, such as to a vessel mounted data recording system.

The use of polyurea enhances robustness of the solid streamer 120 while providing neutral buoyancy through incorporation of the microspheres.

### Hydrophones

In yet still another embodiment, the solid streamer includes an over pressurization structural element. Herein, an example is provided of a method of constructing a seismic streamer incorporating a unique turbulent boundary layer noise cancelling hydrophone that employs a unique method of preventing damage to the hydrophone due to over pressurization. The structural element enhances durability and robustness of the solid streamer.

In one case, the streamer 120 comprises a set of spaced acoustic sensors or hydrophones that are distributed within sections of the streamer cable 120. A novel thin film PVDF hydrophone embodying multiple sensors within each hydrophone embodiment designed to mitigate noise due to flow of fluid over the surface of the streamer is used. The hydrophones are distributed along the length of the streamer 120 in nested groups comprised of a number of hydrophones electrically connected together to form a nested aperture with specific properties associated with the size and spacing of the hydrophones within each group. The spacing of the hydrophones within the a group is designed to address the performance of the group with respect to self-noise. The hydrophones are comprised of a rigid mandrel over which is molded a polyurethane form, such as an about sixty percent glass filled Isoplast® (Dow Chemical, Midland, Mich.) polyurethane form shape in a manner allowing an extruded polycarbonate sleeve to be attached with the molded form of the hydrophone forming the shoulders to which the polycarbonate sleeve is mounted. A second Isoplast® end is molded separately and apart from the molded form, which then mounts to the end of the mandrel and interlocks with the molded form to creates the opposite shoulder to which the polycarbonate sleeve is mounted. This action forms a rigid mandrel with a stress isolation shoulder located at each end that isolates longitudinally travelling energy from the acoustic sensor reducing noise due to vibration from imparting to the acoustic sensor.

### Acoustic Diaphragm:

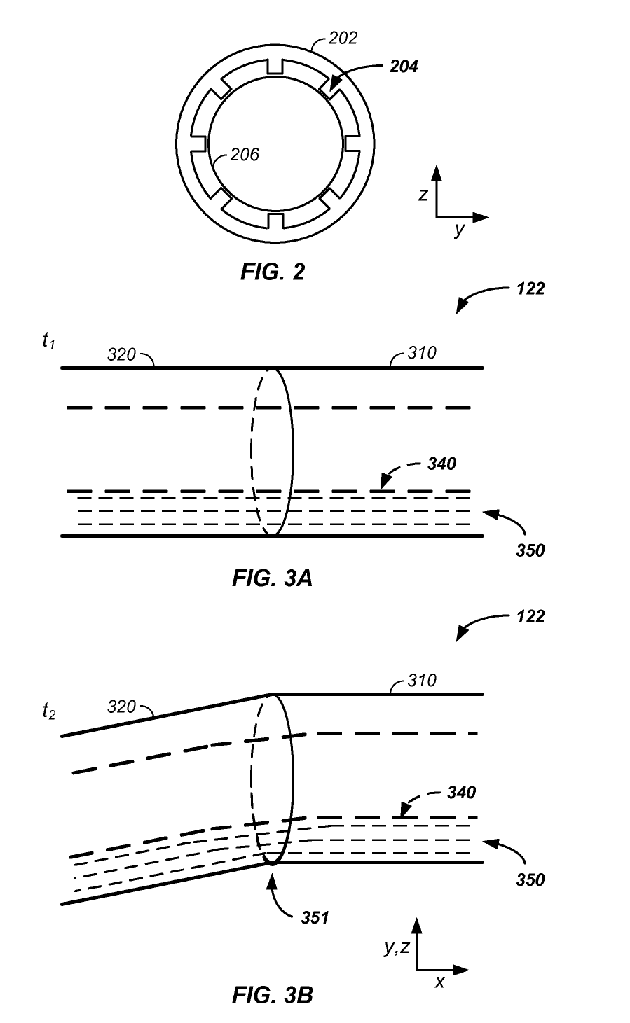

Referring now to FIG. 2, a cross-section illustration of a sleeve 202, such as a polycarbonate sleeve is provided. The polycarbonate sleeve is unique in that the design of the “acoustic diaphragm” incorporates a set of ridges 204 running longitudinally along an inner diameter of the sleeve 202, where the ridges 204, also referred to as ribs, protrude radially inward from the inner diameter of the sleeve 202. This capability has only become available with the implementation of extrusion as the method of manufacture of the polycarbonate tube. The purpose of the ridges 204 in the function of the hydrophone is to prevent hydrostatic pressure due to operating the hydrophones beyond their recommended depth rating from destroying the polycarbonate diaphragm and the associated PVDF element attached to the outside diameter of the polycarbonate tube. As pressure is applied the circumference of the polycarbonate tube shortens. Due to the yield characteristics of the polycarbonate material, the amount of shortening must be limited. Unfortunately, the ability to produce a perfect tube is beyond current technology. Therefore, a method of changing the response to shortening is disclosed wherein at a point prior to the polycarbonate tube reaching yield the ridges come into contact with the rigid mandrel 206. At this point the deformation becomes discretized to the sections between the ridges thus preventing the circumstance where the weakest part of the tube collapses and propagates the deformation circumferentially around the tube with all deformation migrating to a single point about the circumference of the rigid mandrel, thus destroying the tube and the associated PVDF element. The discreet sections deform independently, shortening until they are no longer convex and begin to elongate between the ribs becoming concave or lengthening until they come into contact with the rigid mandrel. The excursion is limited to prevent the polycarbonate from going into yield at any time during this deformation process. As external pressure is relieved, the internal pressure of the cavity between the polycarbonate tube and the rigid mandrel causes the polycarbonate tube to expand until it reaches equilibrium thus preventing damage to the diaphragm and the PVDF element.

Generally, the use of polyurea to form the flotation material for a solid streamer is unique in the art. Use of this material enhances the durability and reliability of solid streamers under all conditions. Incorporation of the ribbed polycarbonate diaphragm within the body of the noise cancelling PVDF hydrophone prevents damage to the acoustic sensors thus vastly improving the reliability of previous PVDF film design in the art.

Completed sensor pairs are then arranged into a group of sensors that forms the acoustic and motion sensor apertures of the seismic streamer section.

The acoustic sensors are typically combined electrically in parallel by use of a twisted pair of conductors connected from one sensor to the next with sufficient length so as to allow for the helix of the wire around the core cable between sensors to prevent breakage when the streamer is bent either in handling or in winding on a reel.

The motion sensors are typically combined electrically in parallel by use of a second twisted pair of conductors connected from one sensor to the next with sufficient length so as to allow for the helix of the wire between sensors to prevent breakage when the streamer is bent either in handling or in winding on a reel.

A completed inner and outer molded sensor section is then over molded with a second form of glass spheres or glass microspheres loaded into an incompressible elastomeric flotation compound that creates a uniform diameter continuous flexible sensor section.

Optional and exemplary relationships between sensor 124 components are further described:
The rigid mandrel or substrate 340 forms the base of the sensor construction.
The electrical wires from each respective sensor are attached together either in parallel or series to create a group of sensors that comprise a discreet channel within the seismic streamer 122.
The group of sensors are placed on the core cable by sliding the cable through the inner diameter of the sensor embodiment.
Each section of the cable is then presented to the process of over molding of the syntactic flotation material which completes the process of construction of the dual sensor seismic section with passive flow noise cancelling.
Electrical connection is made to the piezoelectric film by crimps that puncture the piezoelectric film and provide a conductive path to which wires are then attached to transmit the desired signal which is a common practice in terminating piezopolymer films.

### Streamer Cable Connector

In one embodiment, elements combining two or more streamer sections of the streamer cable 122 are further described herein.

Generally, a connector is used to longitudinally join two streamer sections. The connector optionally contains an interior rigid element. The connector contains at least one of: (1) means for distributing stress over a larger volume or along a longer x-axis length of the streamer relative to the absence of the means for distributing; (2) forming an increasing radius of curvature along the length of the connector as a function of distance from a leading streamer cable section; and (3) co-moving an inner stress bearing element and an outer wall of the connector allowing intermediate elements, such as a wire bundle from picking up noise related to the movement stress.

Referring now to FIG. 3A and FIG. 3B, a streamer cable 122 is illustrated with a first streamer section 310 joined at a terminal end to a first end of a second streamer section 320. Both a hollow rigid mandrel 340 and a wire bundle 350 extend longitudinally through the streamer cable 122. Referring now to FIG. 3A, at a first time, t₁, a junction between the first streamer section 310 and the second streamer section 320 of the streamer cable 122 is aligned and no stress is placed onto the wire bundle 350 at the junction. Referring now to FIG. 3B, at a second time, t₂, the junction between the first streamer section 310 and the second streamer section 320 of the streamer cable 122 is bent, such as about 2, 4, 6, 8, 10, 15, or 20 degrees, and stress is placed onto the wire bundle 350 at the junction in the compressed volume 341 between the rigid mandrel and an outer surface of the streamer cable 122. The stress on the wire bundle 350 in the compressed volume 341 may result in undesirable added noise in signals carried by the wire bundle 350.

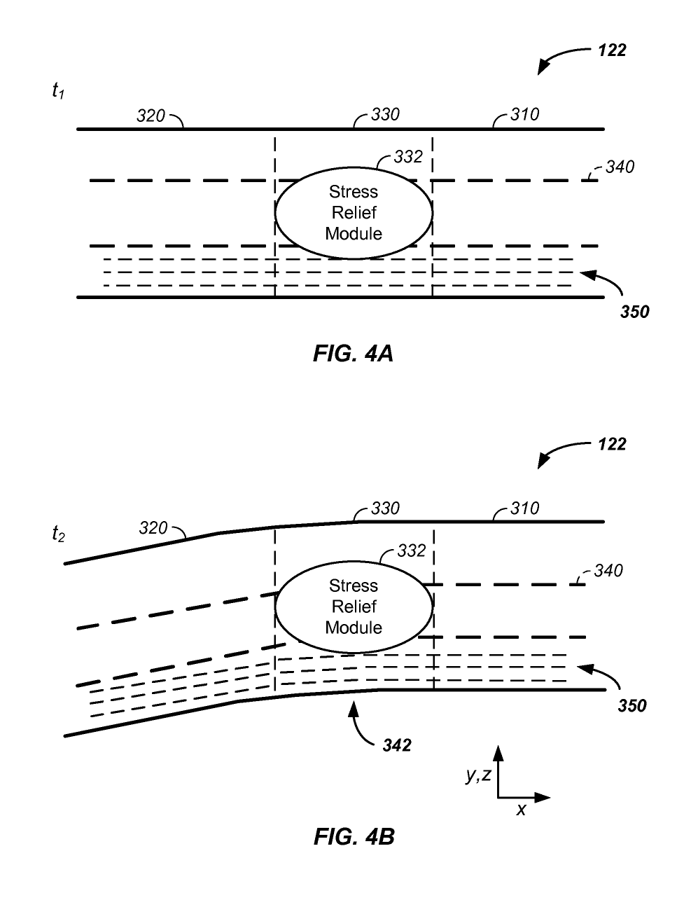

Referring now to FIG. 4A and FIG. 4B, a streamer cable 122 is illustrated with a connector 330 between a terminal end of the first streamer section 310 and the first end of the second streamer section 320. The streamer cable is illustrated in an aligned configuration at a first time, t₁, and in a bent configuration at a second time, t₂. The connector optionally and preferably contains a stress relief module 332. The stress relief module 332 reduces and/or eliminates added noise in the wire bundle 350 when the alignment of the second streamer section 320 is bent relative to the first streamer section 310 due to a reduced compression volume 342 about the wire bundle 350 between the hollow mandrel 340 and the out surface of the streamer cable 122 in the connector 330. For example, when the second streamer section 320 of the towed array 120 bends relative to the first streamer section 310 along the y- and/or z-axes, the stress relief module distributes the resultant stress over a longer section of the streamer cable 122 resulting in less compression per unit volume and/or longitudinal x-axis in the reduced compression volume 342. The distributed compression reduces and/or eliminates noise picked up in the wire bundle 350 resultant from bending of the second streamer section 320 relative to the first streamer section 310.

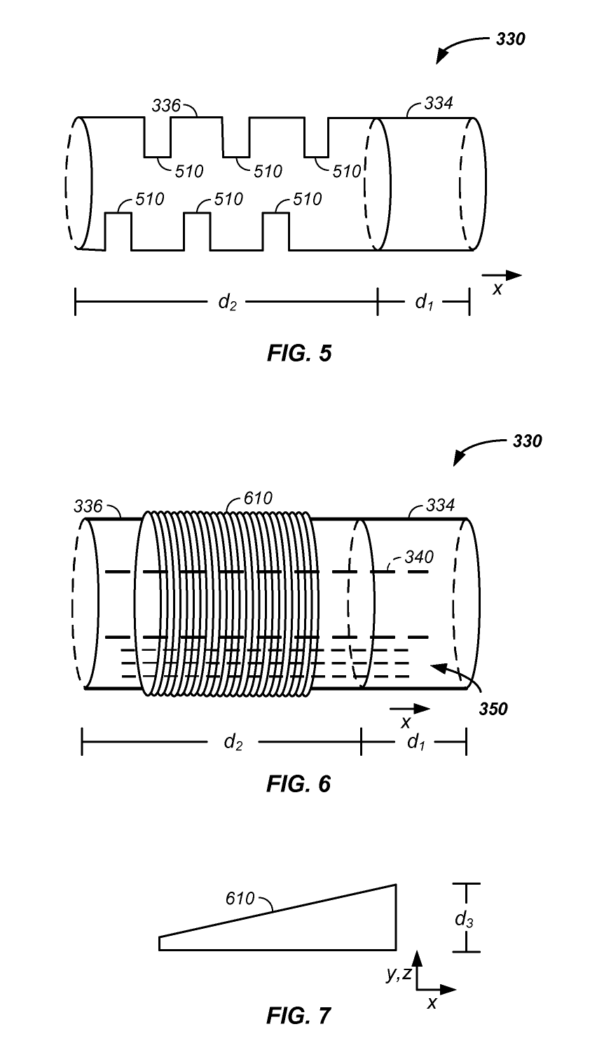

Referring now to FIG. 5, a stress reduction joiner or connector 330 is illustrated. In use, the stress reduction joiner is used to longitudinally join the first streamer section 310 to a second streamer section 320. In this example, the connector includes at least two sections. A first connector section 334 is optionally rigid and is used to connect to the terminal end of the first streamer section 310. A second connector section 336 of the connector 330 is optionally flexible along the y- and/or z-axes and connects at a first end to the first connector section 334 and connects at a second end to the second connector section 336. Optionally, the first connector section 334 is integrated with the second connected section 336. Herein, the flexible second connector section 336 bends along the x-axis by about 2, 4, 6, 8, 10, 15, or 20 degrees and/or is flexible relative to the rigid first connector section 334. Optionally, the first connector section 334 has a first x-axis length, d₁, and the second connector section 336 has a second x-axis length, d₂. Optionally, the first x-axis length, d₁, is shorter than the second x-axis length, d₂, such as about 10, 20, 30, 40, 50, 60, 70, or 80 percent of the second x-axis length. Optionally, the second connector section 336 is used in the absence of the first connector section 334. Generally, the resistance of the connector 330 to one or more y- and/or z-axes stresses is constant as a function or x-axis position or more preferably decreases as a function of x-axis distance away from the first streamer section 310. Generally, any of the elements described herein are usable with and/or are integrated into any of the connectors 330 described herein. Further, additional connectors are used to connect additional streamer sections to the streamer cable 122 and still additional connectors are used in separate streamer cables of the towed array 120.

Still referring to FIG. 5, a first example of flexing means in the connector 330 or second connector section 336 is illustrated. In this example, the second connector section 336 includes an outer wall with divots, cuts, grooves, and/or channels 510 cut into the outer wall. For clarity of presentation, the divots, cuts, and/or grooves are referred to herein as channels 510. The channels interrupt the longitudinal integrity of the outer wall of the second connector section 336, which allows the second connector section 336 to bend along the y- and/or z-axes in response to stress of misalignment of the first streamer section 310 relative to the second streamer section 320. Optionally, the channels 510 run along any combination of the x-, y-, and z-axes. Preferably, the channels run circumferentially around the second connector section 336 at a given x-axis position. The width and/or depth of the channels 510 is optionally a function of x-axis position in the connector 330. For example, the widths and/or depths of the channels 510 optionally increase with increased distance from the terminal end of the first streamer section 310, which yields greater resistance to axial stresses at the first end of the connector 330 and less resistance to axial stresses at the second end of the connector 330.

Referring now to FIG. 6, a second example of flexing means in the connector 330 or second connector section 336 is illustrated. In this example, the second connector section 336 includes a spring 610. As illustrated, the spring 610 wraps circumferentially about the connector 330. Optionally, the spring 610 is partially embedded into the connector 330 or is circumferentially encased by at least part of the connector 330. The spring is used to lengthen the x-axis length of bend in the connector 330, which reduces and/or eliminates induced noise picked up in the wire bundle 350 as a result of reduced stress and/or pressure over a smaller x-axis length of the connector in the absence of the spring 610. Any of the features of the first connector section 334 and/or second connector section 336, described supra, are optionally used with any connector 330 using a stress relief spring. Optionally, the number of windings of the spring 610 per x-axis unit length is a function of x-axis position on the connector, as described infra.

Referring now to FIG. 7, a third example of flexing means in the connector 330 or second connector section 336 is illustrated. In this example, the second connector section 336 includes a spring 610 where the diameter or y/z-axes cross-sectional area of the spring 610 is a function of x-axis position. For example, as illustrated in FIG. 7, the thickness, d3, of the spring 610 decreases with increased distance from the first streamer section 310. The decrease in thickness, d3, of the spring 610 with x-axis position is optionally a continuous function and/or a step function. The decreased resistance to y- and/or z-axes stresses as a function of x-axis position from the first streamer section 310 both spreads out pressure on the reduced pressure volume 342 and allows for a greater radius of curvature of the bend in the connector 330 compared to use of a uniform resistance to y- and/or z-axes stresses. For example, a small deflection of the connector 330 occurs at a first x-axis location and progressively and/or geometrically larger deflections of the connector 330 occur at greater distances from the first connector end, which allows radii of curvatures of the bend of the connector 330 to increase with x-axis position relative to the first end of the connector 330 connecting to the first streamer section 310.

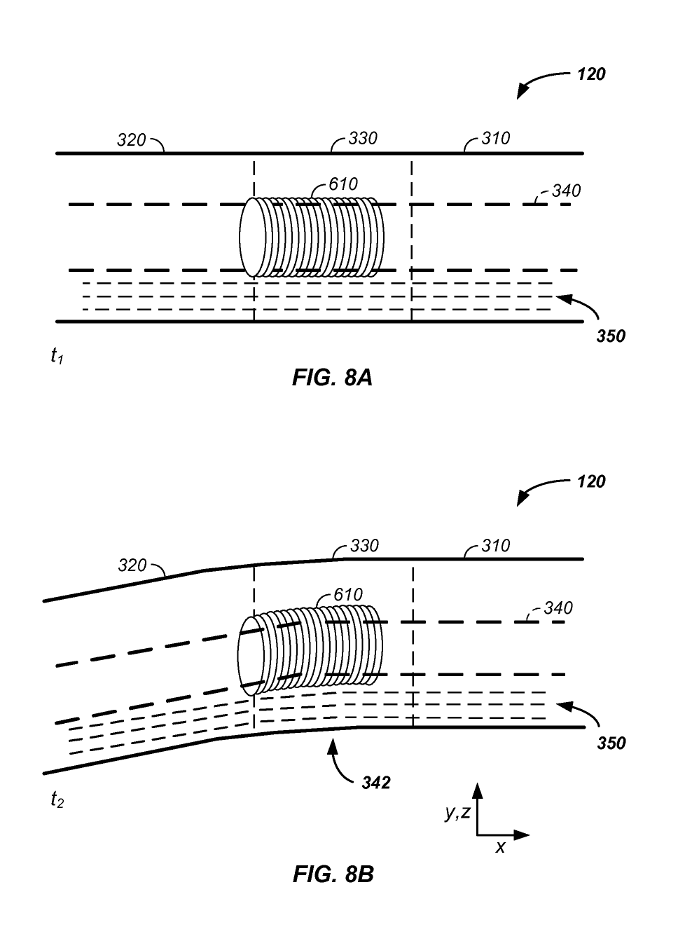

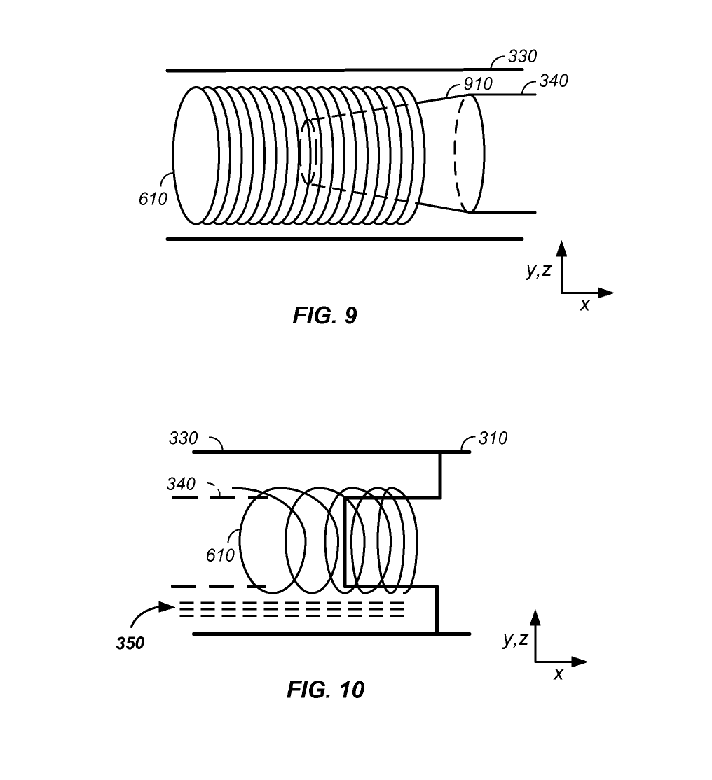

Referring now to FIG. 8A and FIG. 8B, a fourth example of flexing means in the connector 330 or second connector section 336 is illustrated. In this example, the second connector section 336 includes a spring 610 wound or inserted over the hollow mandrel 340 or an extension of the hollow mandrel 340 into the connector 330. For instance, the spring is wound over a cone or tube affixed to one or more elements of the first streamer section 310, such as a tube protruding from and/or affixed to the mandrel 340 of the first streamer section 310. Referring now to FIG. 8A, at a first point in time, t₁, the spring 610 is in a relaxed state about the mandrel extension in the connector while the first streamer section 310 and second streamer section 320 are aligned along the x-axis. Referring now to FIG. 8B, at a second point in time, t₂, the spring 610 is in a higher y- and/or z-axes energy state relative to the relaxed state. The higher y- and/or z-axes energy state is responsive to y- and/or z-axes stresses resultant on the spring 610 due to bends in second streamer section 320 relative to the first streamer section 310. Here, the spring 610 moves with a rigid, solid or hollow, inner tube of the connector 330. The outer wall of the connector 330 moves with the spring 610 as it deforms with stress. As a result of the co-movement of the stress carrying spring 610 and outer wall of the connector 330, the wire bundle 350 volume in the connector is not compressed with bends in the streamer and compression noise is not induced in the wire bundle 350.

Referring now FIG. 9, a fifth example of flexing means in the connector 330 or second connector section 336 is illustrated. In this example, the second connector section 336 includes a spring 610 wound or inserted over an internal rigid connector section 910, which is directly or indirectly affixed to the rigid tube or hollow mandrel of the first streamer section 310. In one parameter, the rigid connector section 910 is longitudinally hollow or is solid. In another parameter, the rigid connector section 910 includes a fixed y-, z-axes cross-sectional area with x-axis position in the connector 330 or has a y-, z-axes cross-sectional area that is a function of x-axis position in the connector 330. As illustrated, the rigid connector section 910 has a cone shape, which allows the spring 610 to deform to a controlled greater degree in the y/z place with increased distance from the first end of the connector 330. Similar to the embodiments described supra, the cone shape allows a set of varying radii of curvatures of the bend of the connector 330 to increase with x-axis position relative to the first end of the connector 330.

Referring now to FIG. 10, a sixth example of flexing means in the connector 330 or second connector section 336 is illustrated. In this example, the second connector section 336 includes a spring 610 wound or inserted over a portion of the hollow mandrel 340 extending out of the first streamer section 310 into the connector 330. In this example, windings of the spring 610 have increased spacing as a function of x-axis position from the first streamer section 310, which allows to spring 610 to progressively increase in y- and/or z-axes deflection in a non-linear or exponential fashion as a function of x-axis position in the connector 330. Optionally, the hollow mandrel 340 optionally extends from the second streamer section 320 into the connector 330.

In a seventh example, the flexing means in the connector, such as the spring 610, are embedded in a semi-flexible connector without a central rigid member or hollow mandrel.

Generally, the connector optionally includes: (1) means that co-move an inner stress reducing element and an outer wall of the connector, such that the wire bundle moves in a uniform space or (2) a system or element for distributing stress over a larger volume or longitudinal length of the streamer relative to the absence of the system or element.

### Method of Manufacture

An example of method of manufacture is described. To make the streamer cable 122, a rigid mandrel or substrate is fabricated to produce a desired form factor for the final embodiment as a seismic streamer or sensor array 120. The substrate or rigid mandrel is over molded to place the required features onto the surface of the rigid mandrel to allow for the mounting and isolation of discreet sensors.

In varying embodiments, the sensor 124 comprises any of:
a thin film piezopolymer acoustic sensor incorporating a flexible microsphere loaded transfer adhesive as the compressible gas chamber providing high sensitivity and immunity to overburden pressure;
a seismic streamer for marine seismic surveys embodying a thin film piezopolymer acoustic sensor incorporating a unique flexible microsphere loaded transfer adhesive as the compressible gas chamber providing high sensitivity and immunity to overburden pressure;
a thin film piezopolymer acoustic sensor incorporating a flexible microsphere loaded transfer adhesive as the compressible gas chamber providing high sensitivity and immunity to overburden pressure combined with zones of non-microsphere loaded transfer adhesive to act as sensors of the turbulent boundary layer whose combined output provides for passive cancelling of noise due to turbulent boundary layer flow;
a seismic streamer for marine seismic surveys embodying a thin film piezo polymer acoustic sensor incorporating a unique flexible microsphere loaded transfer adhesive as the compressible gas chamber providing high sensitivity and immunity to overburden pressure combined with zones of non-microsphere loaded transfer adhesive to act as sensors of the turbulent boundary layer whose combined output provides for passive cancelling of noise due to turbulent boundary layer flow;
a monolithic sensor or multiple sensors housed in a single housing, such as a rigid housing, dual output, flow noise cancelling acoustic and liquid metal uniaxial motion sensor embodied in a flexible elastomer, such as a syntactic elastomer, based solid seismic streamer for marine seismic surveys;
a seismic streamer for marine seismic surveys embodying a thin film piezo polymer acoustic sensor incorporating a flexible microsphere loaded transfer adhesive as the compressible gas chamber providing high sensitivity and near immunity to overburden pressure combined with zones of non-microsphere loaded transfer adhesive to act as sensors of the turbulent boundary layer whose combined output provides for passive cancelling of noise due to turbulent boundary layer flow;
a monolithic dual output, acoustic and motion sensor co-located within a single discreet housing;
a monolithic dual output, acoustic sensor and motion sensor utilizing an acoustic sensor employing a flexible piezopolymer film, such as a syntactic backed piezopolymer film embodiment;
a monolithic dual output, acoustic and motion sensor utilizing a liquid metal electrode arrangement, which uses gravity to place the fluid mass and electrode in such a manner as to allow for sensing only vertical motion and rejecting undesirable motion;
a monolithic dual output, acoustic and acceleration sensor utilizing a novel pressure isolation method to prevent acoustic response in the motion sensor response;
a seismic streamer for marine seismic surveys embodying a thin film piezo polymer acoustic sensor incorporating a flexible microsphere loaded transfer adhesive as the compressible gas chamber providing high sensitivity and immunity to overburden pressure combined with zones of non-microsphere loaded transfer adhesive to act as sensors of the turbulent boundary layer whose combined output provides for passive cancelling of noise due to turbulent boundary layer flow combined with a novel monolithic dual output, acoustic and motion sensor utilizing a novel liquid metal electrode arrangement which uses gravity to place the fluid mass and electrode in such a manner as to allow for sensing only vertical motion and rejecting undesirable motion;
a monolithic dual output, acoustic and motion sensor embodied within a flexible syntactic seismic streamer in groups that are nested in complex spacing arrangements to enhance rejection of undesirable signals; and
a monolithic dual output, acoustic and motion sensor embodied within a flexible syntactic seismic streamer allowing for the core electromechanical cable to reside within the diameter of the sensor embodiment.

### Streamer Positioner/Coupler Connection

In another embodiment, a connector is used to relieve forces resultant at and/or near a junction of a seismic streamer positioner and a seismic streamer section.

Herein, the seismic streamer positioner is also referred to as a depth controller. A depth controller is used to control the depth of tow of the streamer. For example, a depth controller is connected using a pair of collars and races connected directly to the outside diameter of the streamer. In this example, the depth controller is generally tube shaped with a set of fins attached to the aft end and two standoffs where the collars attach it to the streamer at the races, which allowed the bird to rotate around the axis of the streamer making it always hang below the streamer. Essentially, the depth controller controls only the vertical position of the streamer in the water body.

Streamer arrays are often used instead of a single streamer, which allows more accurate and precise three-dimensional maps of underlying strata layers. To enhance performance of the towed array, spacing between individual streamers in the array is preferably controlled. For example, a known and/or controlled distance between any two cables of an array of cables is preferred. The controlled position of each cable is achieved using birds, described infra.

Herein, the seismic streamer positioner is also referred to as a bird, a bird positioner, and/or as a bird controller. A bird or seismic streamer positioner is used for control and/or positive control of one or more of: lateral position of a streamer position, vertical control of a streamer position, roll control of a streamer position, orientation of a streamer cable, depth of a streamer cable, separation of two or more streamer cables in a streamer array, and/or control of a trailing end of one or a set of streamers. Multiple bird positioners are optionally and preferably used for each streamer cable.

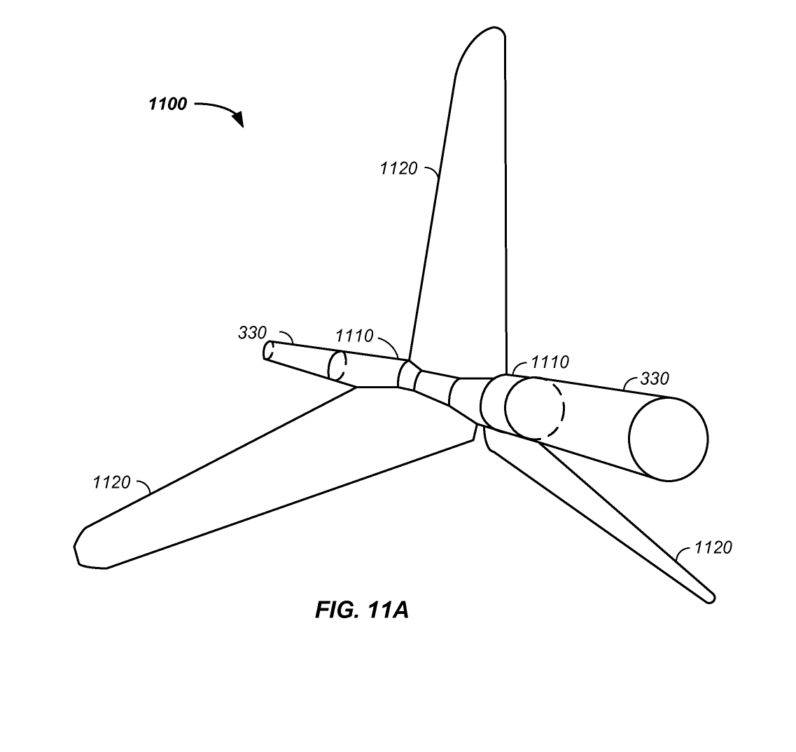

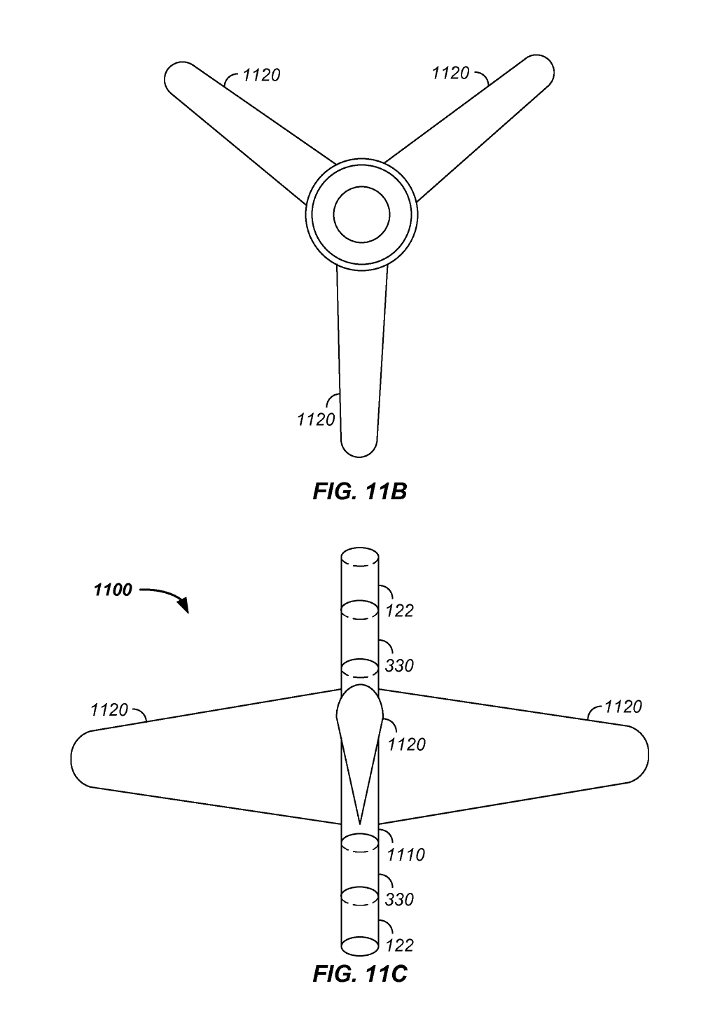

Referring now to FIGS. 11A-C, a perspective, end, and top view, respectively, of a bird positioner 1100 relative to one or more couplers 330 and relative to one or more streamer sections 122 is provided. The bird positioner 1100 includes a central tube shaped member 1110, which is optionally a hollow shaft carrying communication lines. For clarity of presentation, the bird positioner 1100 is illustrated with three fins; however, any number of fins for a given bird positioner are optionally used, such as 2, 3, 4, 5, or more fins. Still referring to FIG. 11A-C, the illustrated bird positioner has three fins at 120 degree intervals around the central member 1110, which is typically a dedicated module that connects between the seismic streamer sections much the same as the digital telemetry modules. The seismic streamer positioner or bird positioner optionally includes: internal inertial guidance, which allows sensor input as to which way is up, internal compasses for determination of direction, and electro and/or mechanical components for control of bearing and azimuth.

The bird positioner is optionally:
constructed of titanium for tensile strength and corrosion resistance;
includes replaceable attached wings to the central tubular member to allow winding on a streamer drum;
contains wireless and/or wired communication elements for long range streamer communication; and/or
contains wireless power transfer between the wing 1120 and the body 1110.

An example of a bird positioner is the eBird® (Kongsberg Maritime, Kongsberg, Norway).

The connector 330, described supra, for connecting a terminal end of the first streamer section 310 and the first end of the second streamer section 320 is optionally used to connect a streamer section 122 to a streamer positioner 1100. Any of the above described elements of the stress relief module 332 are optionally used in a streamer positioner connector. Further, the orientation along the x-axis of any of the above described connector 330 elements are optionally reversed to face up a length of the streamer cable 122 as opposed to the above described elements facing down the length of the streamer cable 122.

For example, any of the above described connectors are used: (1) to connect at a first end to a streamer cable 122 and at a second end to the streamer positioner 1100 or (2) to connect at the first end to a streamer positioner 1100 and at the second end to a streamer cable 122 section. Similarly, the connector is optionally used at the tail end of a series of streamer sections to connect to a trailing streamer positioner.

Still yet another embodiment includes any combination and/or permutation of any of the sensor elements described herein.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

Although the invention has been described herein with reference to certain preferred embodiments, one skilled in the art will readily appreciate that other applications may be substituted for those set forth herein without departing from the spirit and scope of the present invention.

1. An apparatus, comprising:
a towable solid streamer, comprising:
an inner longitudinal stress bearing member;
an outer sleeve;
a urea linked polymer between said inner longitudinal stress bearing member and said outer sleeve; and
at least one sensor positioned in said solid streamer between said inner longitudinal stress bearing member and said outer sleeve.

2. The apparatus of claim 1, said urea linked polymer comprising a form of polyurea.

3. The apparatus of claim 1, said urea linked polymer comprising a polyurea linkage.

4. The apparatus of claim 1, wherein said urea linked polymer comprises urea linkages between alternating starting monomer reaction units of at least one form of an isocyanate and at least one form of an amine.

5. The apparatus of claim 1, wherein said urea linked polymer comprises an elastomer derived from the reaction product of an isocyanate and a resin.

6. The apparatus of claim 1, said resin comprising at least one of:
an amine terminated polymer resin; and
an amine terminated chain extender.

7. The apparatus of claim 5, further comprising:
flexible hollow glass microspheres intercalated in said urea linked polymer.

8. The apparatus of claim 5, said elastomer comprising a flexible hollow glass microsphere additive.

9. The apparatus of claim 1, further comprising:
at least one longitudinal rib integrated into said outer sleeve, said at least one longitudinal rib forming a ridge extending radially inward from an inner side of said outer sleeve.

10. An apparatus, comprising:
a towable solid streamer, comprising:
an inner longitudinal stress bearing member;
an outer sleeve;
a form of polyurea between said inner longitudinal stress bearing member and said outer sleeve; and
at least one sensor positioned in said solid streamer between said inner longitudinal stress bearing member and said outer sleeve.

11. The apparatus of claim 10, further comprising:
flexible hollow glass microspheres distributed in said polyurea.

12. The apparatus of claim 11, further comprising:
at least one longitudinal rib extending radially inward from said outer sleeve.

13. The apparatus of claim 11, wherein said at least one sensor comprises at least one of:
an acoustic sensor; and
a sensor using polyvinylidene fluoride.

14. The apparatus of claim 10, further comprising:
a shark skin stimulant proximate an outer surface of said outer sleeve.

15. A method for forming a towable solid streamer, comprising the steps of:
providing an inner longitudinal stress bearing member;
providing an outer sleeve;
forming a polyurea between said inner longitudinal stress bearing member and said outer sleeve; and
positioning at least one sensor in said towable solid streamer proximate said inner longitudinal stress bearing member.

16. The method of claim 15, further comprising the steps of:
providing a diisocyanate;
providing a polyamine; and
reacting said diisocyanate and said polyamine to form said polyurea.

17. The method of claim 16, further comprising the step of:
preheating said diisocyanate to at least one hundred thirty degrees Fahrenheit.

18. The method of claim 16, further comprising the step of:
prior to said step of reacting, blending hollow microspheres into at least one of:
said diisocyanate; and
said polyamine.

19. The method of claim 18, said step of blending further comprising the step of:
controlling specific gravity of said polyurea through control of a first amount of said hollow microspheres relative to a second amount of at least one of said diisocyanate and said polyamine.

20. The method of claim 16, further comprising the step of:
using connectors to connect sections of said towable solid streamer containing said at least one sensor.
